(19) United States
(12) Patent Application Publication
(10) Pub. No.: US 2003/0141156 A1
(43) Pub. Date: Jul. 31, 2003

(54) Hydrodynamic machine for transmitting torques

(76) Inventors: Jurgen Friedrich, Craileheim (DE); Peter Heilinger, Crailsheim (DE); Klaus Vogelsang, Crailsheim (DE); Ernst-Ulrich Jaeger, Steinheim (DE)

Correspondence Address: Baker & Daniels, Suite 800, 111 East Wayne Street, Fort Wayne, IN, 46802, US

(21) Appl. No.: 10/258,639

(22) PCT Filed: Apr. 19, 2001
(86) PCT No.: PCT/EP01/04423

(30) Foreign Application Priority Data
Apr. 28, 2000 (DE) 100 20 944.0

(51) Int. Cl. F16D 57/02

(52) U.S. Cl. 188/296

(57) ABSTRACT

The invention relates to a hydrodynamic machine for transmitting torque. Said machine is equipped with the following features: a rotor-blade wheel (2); a stator-blade wheel (3); when viewed in a cylindrical cut, the blades (2.1, 3.1) are embodied and disposed as follows: they extend in planes which are inclined towards the axis (1.1) of the machine; they are substantially aligned relative to one another; they are angled with the purpose of forming a tip (2.6, 3.6). In order to reduce losses due to shock and to enhance efficiency, at least the flow areas of the edge of the blades are angled on both sides, when viewed in a cylindrical cut, so that the tip is located between the lateral limiting surfaces (2.3, 2.4. 3.3, 3.4) of the corresponding blade.

The invention concerns a hydrodynamic machine, especially a retarder. In addition, it concerns other hydrodynamic machines, which serve the purpose to transmit torque by the means of a hydrodynamic medium, for example by the means of oil or by the means of water. Hydrodynamic couplings as well as converters can also be considered for further machines.

Machines of this kind are well known from numerous publications. Only as an example it is referred to DE 31 13 408 C1. This document concerns a retarder.

When developing such machines, particularly the increase of the efficiency is of concern. It is also desired to design such a machine in such a way that it can be operated with different operating conditions in a desired manner. For the retarder it is mainly desired to achieve as high a power density as possible. One aims at an ideal design of the parts taking part in the energy exchange, above all the rotor and the stator.

The achieved efficiencies are impressive. Nevertheless, further improvements are desired.

The invention is based on the task to design a hydrodynamic machine in such a manner that the efficiency is further improved.

The features described in claim 1 solve this task.

The inventors recognized a feature, which is of substantial importance for the efficiency. This feature concerns the shape of the individual blade edge. It is well known to chamfer or sharpen the blade edges. It is however surprising that a relatively simple measure can achieve a significant improvement. If the blade edges are chamfered in a way according to the invention, then thereby shock losses are minimized and the efficiency is increased significantly. In accordance with the invention chamfering within the flowed against blade areas is chamfered on both sides of the blade tip, thus not only on one side, as this was the case until then.

It is known that in a torus-shaped workspace of a fluid-flow machine of the kind mentioned, for example of a retarder, an almost circular current takes place. Each blade edge thereby is flown against by the working medium on a part of its length—seen in perpendicular direction—, while the working medium on another part of the blade length. flows away. In accordance with the invention the flowed against blade edge areas are chamfered on both sides of the theoretical blade center.

The invention is described in more detail with the drawing. The following is detailed represented:

FIG. 1 shows a Retarder in schematic representation in a half-section through an axial plane.

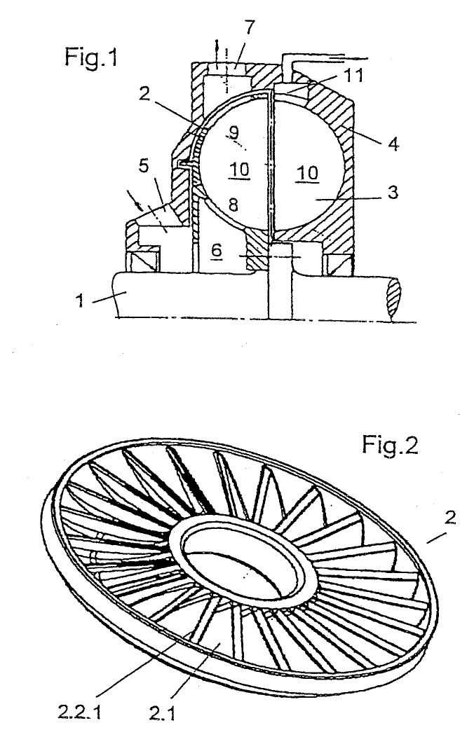

FIG. 2 shows in perspective representation a rotor-blade wheel.

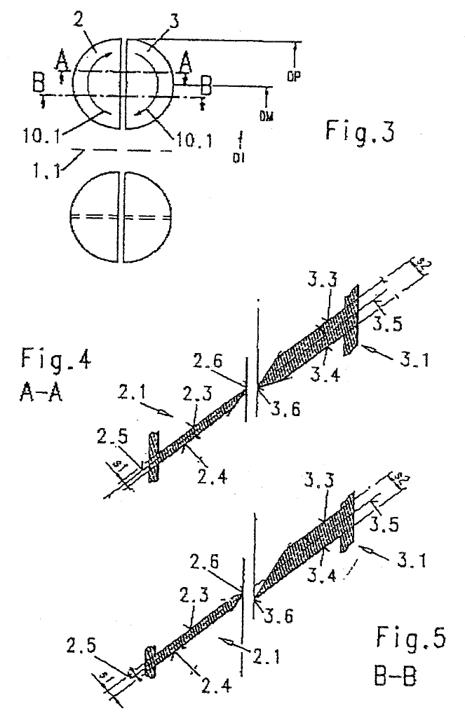

FIG. 3 shows a further schematized representation similar to FIG. 1.

FIG. 4 shows a cut from a cylindrical section A-A through the subject of FIG. 3.

FIG. 5 shows a cut from a cylindrical section B-B through the subject of FIG. 3.

The retarder shown in FIG. 1 exhibits a driving shaft 1, on which a rotor-blade wheel 2 is wedged up, furthermore a stator-blade wheel 3, which is arranged in a housing 4 with torsional strength. The work liquid is supplied to the retarder by an inlet channel 5 by way of control equipment not represented here. It arrives first into a distributor area 6. It is again removed with an outlet channel 7. At the rotor-blade wheel in the radially internal area are filling slots 8 located, as well as in the radially outside area emptying slots 9, which are however without meaning for the invention. Between the rotor-blade wheel and the stator-blade wheel is a torus-shaped workspace 10, which is filled and emptied through the filling slots and emptying slots 8 and 9.

The rotor-blade wheel 2 shown in FIG. 2 shows a multiplicity of blades 2.1. Each blade 2.1 exhibits a blade edge 2.2.1, of which one is nominated.

In the schematic representation in accordance with FIG. 3 the axis 1.1 of the driving shaft not represented here can be recognized, furthermore the rotor-blade wheel 2 and the stator-blade wheel 3. In the torus-shaped workspace formed by the two wheels the working medium performs a circular current—sees the arrows 10.1.

The retarder exhibits a profile diameter DP, furthermore a so-called center diameter DM and an inside diameter DI.

FIGS. 4 and 5 illustrate the two cylindrical sections A-A and B-B.

In both figures the rotor blades 2.1 are represented on the left, and the stators blades 3.1 are represented on the right. The edges of the blades exhibit in each case a tip. They are chamfered in different way.

For the rotor blade 2.1 of FIG. 4 chamfering it in a traditional way creates the tip. As it can be seen, the rotor blade 2.1 exhibits a thickness s1. Lateral areas 2.3, 2.4 limit the blade. Between them is the theoretical blade center plane 2.5. The tip 2.6 lies in the plane of the lateral limiting surface 2.3.

The conditions are different for the stator blade 3.1 in accordance with FIG. 4. The stator blade 3.1 exhibits a thickness s2. The tip 3.6 is in the theoretical blade center plane 3.5. Thus two chamfers are made.

The cylindrical section A-A is put into a diameter area of the retarder, in which working medium flows away from the edge of the rotor blade 2.1, but flows against the edge of the stator blade 3.1.

In the representation in accordance with FIG. 5 with cylindrical section B-B one recognizes again the rotor blade 2.1.1 and the stator blade 3.1.

Here things are reversed compared to the representation in accordance with FIG. 4. An area is represented at the stator blade 3.1, of which the working medium flows away, and an area is represented at the rotor blade 2.1, to which working medium flows. Here accordingly the tip 3.6 of the stator blade 3.1 is offset from the longitudinal center plane 3.5 of the blade. It lies in the plane of the lateral limiting surface 3.4.

The blades are arranged “lanced” in a well-known way. The tips are thus turned towards each other. The blades of rotor and stator are in this representation are arranged essentially in alignment with one another.

The arrangement according to the invention leads to a minimization of the shock losses and thus to a significant increase of efficiency and quiet running.

1. Hydrodynamic machine for transmitting torque;
1.1. With a rotor-blade wheel (2);
1.2. With a stator-blade wheel (3);
1.3. When viewed in a cylindrical cut, the blades (2.1, 3.1) are embodied and arranged as follows:
1.3.1. They extend in planes, which are inclined towards the axis (1.1) of the machine;
1.3.2. They are substantially aligned relative to one another;
1.3.3. They are chamfered with the purpose of forming a tip (2.6, 3.6); characterized by the following features:
1.4. At least the flow areas of the blade edges (leading flow areas) are chamfered on both sides—when viewed in a cylindrical cut—so that the tip (2.6, 3.6) is located between the lateral limiting surfaces (2.3, 2.4; 3.3, 3.4) of the corresponding blade (2.1, 3.1).

2. Machine according to claim 1, characterized by the fact that also the trailing flow areas are designed like the leading flow areas.

3. Machine according to claim 1 or 2, characterized by the fact that the angles between the blade center plane (2.5, 3.5) and the plane of the chamfer are between 10 and 30°, preferably 20°.

4. Machine according to one of the claims 1 to 3, characterized by the fact that the length of the chamfered area of the rotor blades (2.1)—when viewed in a cylindrical cut—is between 1 and 3 mm on the blade pressure side, and is between 3 and 5 mm on the pressure opposite blade side.

5. Machine according to one of the claims 1 to 4, characterized by the fact that the length of the chamfered area of the stators (3.1)—when viewed in a cylindrical cut—is between 8 and 12 mm on the blade pressure side, and is between 14 and 20 mm on the pressure opposite blade side.

6. Machine according to one of the claims 1 to 5, characterized by the fact that the stator-blade wheel (3) exhibits thick and thin blades (3.1).

7. Machine according to one of the claims 1 to 6, characterized by the fact that the thin stators within the leading flow area exhibit the same blade shape as the one of the rotor blades within the leading flow area.

8. Machine according to one of the claims 1 to 7, characterized by the fact that the tips (2.6, 3.6) of the blades (2.1, 3.1) are rounded.

9. Machine according to one of the claims 1 to 8, characterized by the fact that it is a hydrodynamic retarder.
